(19) United States
(12) Patent Application Publication
(10) Pub. No.: US 2007/0003443 A1
(43) Pub. Date: Jan. 4, 2007

(54) THERMAL-CYCLING PIPETTE TIP

(75) Inventors: Donald R. Sandell, San Jose, CA (US); Ralph Somack, Oakland, CA (US); Ian A. Harding, San Mateo, CA (US); Dennis Lehto, Santa Clara, CA (US)

Correspondence Address: MILA KASAN, PATENT DEPT.;APPLIED BIOSYSTEMS, 850 LINCOLN CENTRE DRIVE, FOSTER CITY, CA, 94404, US

(73) Assignee: APPLERA CORPORATION, Foster City, CA (US)

(21) Appl. No.: 11/426,289

(22) Filed: Jun. 23, 2006

Related U.S. Application Data
(60) Provisional application No. 60/694,112, filed on Jun. 23, 2005.

(51) Int. Cl. B01L 3/02

(52) U.S. Cl. 422/100

(57) ABSTRACT

A pipette tip and system for aspiration of a biological sample, distribution to a plurality of sample chambers, and thermal cycling in the pipette tip.

### CROSS REFERENCE TO RELATED APPLICATIONS

This application claims a priority benefit under 35 U.S.C. § 119(e) from U.S. patent application Ser. No. 60/694,112, filed Jun. 23, 2005.

### FIELD

The present teachings relate to systems and methods for multiple analyte detection.

### BACKGROUND

Biochemical testing for research and diagnostic applications can require simultaneous assays including a large number of analytes in conjunction with a one or a few samples. Such testing can include extended sample manipulation and sealing of test devices. It is desirable to provide a method for analyzing one or a few biological samples by aspirating, storing, sealing, providing optical access. It is desirable to provide a single test device with a plurality of analytes in individual sample chambers, where the device can aspirate the sample directly, can be sealed, and can provide optical access to each of the sample chambers. It is desirable to integrate a pipette tip with a tube strip or multi-well tray to aspirate a sample directly into each tube or well in series and sealably isolate each tube or well in the pipette tip.

### SUMMARY

In various embodiments, the present teachings can provide a pipette tip for aspiration and thermal-cycling of a biological sample, the pipette tip including a sample inlet port, a pipettor interface, multiple sample chambers, wherein the sample chambers are configured to fit into recesses of a thermal cycling block, and a sample distribution network, wherein the sample distribution network connects the sample inlet port to the pipettor interface. In some embodiments, the sample distribution network connects the sample inlet port to each sample chamber via an inlet channel, where the inlet channel is of uniform size or of variable size, which can include a main channel and a branching channel where the main channel decreases in size. In some embodiments, the sample distribution network connects the pipettor interface with each sample chamber via an aspiration channel, which can include a direct connection or a branched connection. In some embodiments, the sample chambers include a wax layer compartment for storing the reagents. In some embodiments, the pipette tip can include multiple sample ports, multiple pipettor interfaces and an array of sample chambers. In some embodiments, the pipette tip can include an optical layer comprising of detection-compatible material, wherein the detection-compatible material aligns with the multiple sample chambers.

In various embodiments, the present teachings can provide a system for thermal cycling of a biological sample including a pipette tip with a sample inlet port, a pipettor interface, an optical surface, the optical surface comprising of detection-compatible material, multiple sample chambers, and a sample distribution network, wherein the sample distribution network connects the sample inlet port to the pipettor interface, and wherein the detection-compatible material aligns with the multiple sample chambers, and a thermal-cycling instrument including a thermal-cycling block with multiple recesses configured to fit the sample chambers, a lid with sealing contacts configured to align with the sample distribution network and optical openings configured to align with the sample chambers, and an optical detector configured to align with the optical openings, the detection-compatible material, and the sample chambers. In some embodiments, the sample distribution network can include an inlet channel and an aspiration channel for each sample chamber. In some embodiments, the lid can provide pressure and/or heat to form a seal in the inlet channel and the aspiration channel. The lid can also provide heat during the thermal cycling of the biological sample. In some embodiments, the optical surface can include multiple lenses aligned to the sample chambers. In some embodiments, the instrument can include a pipettor configured to connect to the pipettor interface. In some embodiments the pipette tip can include multiple sample ports, multiple pipettor interfaces, and an array of sample chambers. In some embodiments, the sample chambers can include a wax layer compartment for storing the reagents.

In various embodiments, the present teachings can provide a system for thermal cycling of a biological sample including means for storing reagents in a plurality of sample chambers, means for distributing the sample to the plurality of sample chambers, means for sealing each of the sample chambers, means for thermally cycling the biological sample, and means for detecting the biological sample.

Additional embodiments are set forth in part in the description that follows, and in part will be apparent from the description, or may be learned by practice of the various embodiments described herein.

### BRIEF DESCRIPTION OF THE DRAWINGS

Various embodiments of the present teachings are exemplified in the accompanying drawings. The teachings are not limited to the embodiments depicted, and include equivalent structures and methods as set forth in the following description and known to those of ordinary skill in the art. In the drawings:

FIG. 1 illustrates a cross-sectional side view of the pipette tip according to various embodiments of the present teachings;

FIG. 2 illustrates a perspective view of an embodiment of the pipette tip according to various embodiments of the present teachings;

FIG. 3 illustrates a perspective view of an embodiment of the pipette tip according to various embodiments of the present teachings;

FIGS. 4A and 4B illustrate a cross-sectional top view of two different embodiments of the sample distribution system according to various embodiments of the present teachings;

FIG. 5 illustrates a cross-sectional side view of a system for thermal cycling a biological sample according to the various embodiments of the present teachings;

FIGS. 6A-6B illustrate a top view and cross-sectional view of a pipette tip according to the various embodiments of the present teachings;

FIGS. 7A-7G illustrate perspective, cross-sectional, and cut-away views of a pipette tip according to the various embodiments of the present teachings;

FIGS. 8A-8D illustrate perspective and cross-sectional views of a pipette tip and pipettor according to the various embodiments of the present teachings; and

FIGS. 9 illustrates a cross-sectional perspective view of a system for thermal cycling a biological sample according to the various embodiments of the present teachings.

It is to be understood that both the foregoing general description and the following detailed description are exemplary and explanatory only and are intended to provide a further explanation of the various embodiments of the present teachings.

### DESCRIPTION OF VARIOUS EMBODIMENTS

In this application, the use of the singular includes the plural unless specifically stated otherwise. In this application, the use of “or” means “and/or” unless stated otherwise. Furthermore, the use of the term “including”, as well as other forms, such as “includes” and “included”, is not limiting. Also, terms such as “element” or “component” encompass both elements and components comprising one unit and elements and components that comprise more than one subunit unless specifically stated otherwise. Wherever possible, the same reference numbers will be used throughout the drawings to refer to the same or like parts.

The section headings used herein are for organizational purposes only, and are not to be construed as limiting the subject matter described. All documents cited in this application, including, but not limited to patents, patent applications, articles, books, and treatises, are expressly incorporated by reference in their entirety for any purpose.

The term “sample chamber” as used herein refers to any structure that provides containment to a sample. The chamber can have any shape including circular, rectangular, cylindrical, etc. Multi-chamber arrays can include 12, 24, 36, 48, 96, 192, 384, 1536, 3072, 6144, or more sample chambers. The term “channel” as used herein refers to any structure that is smaller than a chamber. A channel can have any shape. It can be straight or curved, as necessary, with cross-sections that are shallow, deep, square, rectangular, concave, or V-shaped, or any other appropriate configuration.

The term “biological sample” as used herein refers to any biological or chemical substance, typically in an aqueous solution with luminescent dye that can produce emission light in relation to nucleic acid present in the solution. The biological sample can include one or more nucleic acid sequence to be incorporated as a reactant in polymerase chain reaction (PCR) and other reactions such as ligase chain reaction, antibody binding reaction, oligonucleotide ligations assay, and hybridization assay. The biological sample can include one or more nucleic acid sequence to be identified for DNA sequencing.

The term “luminescent dye” as used herein refers to fluorescent or phosphorescent dyes that can be excited by excitation light or chemiluminscent dyes that can be excited chemically. Luminescent dyes can be used to provide different colors depending on the dyes used. Several dyes will be apparent to one skilled in the art of dye chemistry. One or more colors can be collected for each dye to provide identification of the dye or dyes detected. The dye can be a dye-labeled fragment of nucleotides. The dye can be a marker triggered by a fragment of nucleotides. The dye can provide identification of nucleic acid sequence in the biological sample by association, for example, bonding to or reacting with a detectable marker, for example, a respective dye and quencher pair. The respective identifiable component can be positively identified by the luminescence of the dye. The dye can be normally quenched, and then can become unquenched in the presence of a particular nucleic acid sequence in the biological sample. The fluorescent dyes can be selected to exhibit respective and, for example, different, excitation and emission wavelength ranges. The luminescent dye can be measured to quantitate the amount of nucleic acid sequences in the biological sample. The luminescent dye can be detected in real-time to provide information about the identifiable nucleic acid sequences throughout the reaction. Examples of fluorescent dyes with desirable excitation and emission wavelengths can include 5-FAM™, TET™, and VIC™. The term “luminescence” as used herein refers to low-temperature emission of light including fluorescence, phosphorescence, electroluminescence, and chemiluminescence.

The term “detector” as used herein refers to any component, portion thereof, or system of components that can detect light including a charged coupled device (CCD), back-side thin-cooled CCD, front-side illuminated CCD, a CCD array, a photodiode, a photodiode array, a photo-multiplier tube (PMT), a PMT array, complimentary metal-oxide semiconductor (CMOS) sensors, CMOS arrays, a charge-injection device (CID), CID arrays, etc. The detector can be adapted to relay information to a data collection device for storage, correlation, and/or manipulation of data, for example, a computer, or other signal processing system.

In various embodiments, sample chambers can be dimensioned to hold from 0.01 μL to 100 μL of sample per chamber, or between 1 μL and 10 μL. Conveniently, the volume of each sample chamber can be between 1 μL and 500 μL.

In various embodiments, the sample channels can be dimensioned to provide sufficient aspiration by a pipettor to deliver the sample to the sample chambers, while occupying as little volume as possible. For example, cross-sectional dimensions for the channels can range from 5 μm to 250 μm for both the width and depth. In some embodiments, the channel path lengths to the sample chambers can be minimized to reduce the total channel volume by positioning the sample chambers closer together. For example, the network can be substantially planar, i.e., the sample channels and sample chambers in the substrate intersect a common plane.

In various embodiments, the pipette tip can be constructed from any solid material that is suitable for conducting analyte detection. Materials that can be used can include various plastic polymers and copolymers, such as polypropylenes, polystyrenes, polyimides, COP, COC, and polycarbonates. Inorganic materials such as glass and silicon can also useful. Silicon is especially advantageous in view of its high thermal conductivity, which facilitates rapid heating and cooling of the pipette tip if necessary. The pipette tip can be formed from a single material or from a plurality of materials.

In various embodiments, the pipette tip can be constructed in layers. A base layer including recesses for the sample chambers can be formed by any suitable method known in the art. For plastic materials, injection molding can be suitable to form sample cavities and connecting channels having a desired pattern. For silicon, standard etching, RIE, DRIE, and wet-etching techniques from the semiconductor industry can be used as known in the art of photolithography.

In various embodiments, the pipette tip can be prepared from two or more laminated layers. The term “detection-compatible material” as used herein refers to the optical access within a pipette tip that includes one or more layers which provide an optically transparency for each sample chamber, through which the luminescent dye can be detected. For this purpose, silica-based glasses, quartz, polycarbonate, or an optically transparent plastic layer may be used, for example. Selection of the particular detection-compatible material depends in part on the optical properties of the material. For example, in luminescent dye-based assays, the material should have low fluorescence emission at the wavelength(s) being measured. The detection-compatible material should also exhibit minimal light absorption for the signal wavelengths of interest.

In various embodiments, other layers in the pipette tip can be formed using the same or different materials. The term “assay-compatible material” as used herein refers to the interaction of assay reagents and assay conditions (heat, pressure, pH, etc.) with the pipette tip material (hydrophobic, hydrophilic, inert, etc.). In various embodiments, the layer or layers forming the recesses defining the sample chambers can be formed predominantly from a material that has high heat conductivity. In various embodiments, the layer or layers forming the recesses can be shaped to fit recesses in a thermal block to provide intimate contact with each sample chamber. The thermal block can be constructed of metal to provide thermal uniformity at different temperatures and uniform transitions while heating and cooling during thermal cycling.

In various embodiments, for optical detection, the opacity or transparency of the detection-compatible material defining the sample chambers, for example, the orientation of the pipette can have an effect on the permissible detector geometries used for signal detection. For the following discussion, references to the “upper wall” of a detection chamber refer to the chamber surface or wall through which the optical signal is detected, and references to the “lower wall” of a chamber refers to the chamber surface or wall that is opposite the upper wall. For example, the upper wall can be formed by a non-fluorescent material, and the lower wall by a different material, respectively.

In various embodiments, in fluorescence detection the pipette tip material defining the lower wall of the sample chambers can be optically opaque, and the sample chambers can be illuminated and optically scanned through the same surface (i.e., the top surfaces of the chambers which are optically transparent). Thus, for fluorescence detection, the opaque lower wall material can exhibit low reflectance properties so that reflection of the illuminating light back toward the detector can be minimized.

In various embodiments, in fluorescence detection the pipette tip material defining the upper wall of the sample chambers can be optically clear, the chambers can be illuminated with excitation light through the sides of the chambers (in the plane defined collectively by the sample chambers in the substrate), or more typically, diagonally from above (e.g., at a 45 degree angle), and emitted light is collected from above the chambers (i.e., through the upper walls, in a direction perpendicular to the plane defined by the detection chambers). The upper wall material can exhibit low dispersion of the illuminating light in order to limit Rayleigh scattering.

In various embodiments, in fluorescence detection the pipette tip material defining the entirety of the pipette can be optically clear, or at least the upper and lower walls of the chambers can be optically clear, the chambers can be illuminated through either wall (upper or lower), and the emitted or transmitted light is measured through either wall as appropriate. Illumination of the chambers from other directions can also be possible as already discussed above.

In various embodiments, in chemiluminescence detection, where light of a distinctive wavelength is typically generated without illumination of the sample by an outside light source, the absorptive and reflective properties of the pipette tip can be less important, provided that the substrate provides at least one optically transparent window for detecting the signal.

In various embodiments, the pipette tip can be designed to provide a sample-distribution network for sample loading similar amounts of sample into each sample chamber, and also to provide sample chambers having carefully defined reaction volumes. An example of a sample-distribution network can be parallel branched channels at the sample entry and/or pipettor interface. Such a network can dedicate one input channel for each sample chamber and one aspiration channel for each sample chamber so that each chamber is filled in parallel at the same time. The lengths of the channels can be designed to provide the same aspiration force to each sample chamber. Another example of a sample-distribution network can be serially branched channels from the sample entry with a branch at each sample chamber. Such a network can size the branching input channels to be proportionally narrower to permit most of the sample to pass to the main channel. The main channel can be gradually narrowed after successive branching input channels such that sample chambers are filled in series.

In various embodiments, the pipette tip layers can be sealably bonded in a number of ways. A suitable bonding substance, such as a glue or epoxy-type resin, can be applied to one or both opposing surfaces that will be bonded together. The bonding substance may be applied to the entirety of either surface, so that the bonding substance (after curing) can come into contact with the sample chambers and the distribution network. In this case, the bonding substance is selected to be compatible with the sample and detection reagents used in the assay. Alternatively, the bonding substance can be applied around the distribution network and sample chambers so that contact with the sample can be minimal or avoided entirely. The bonding substance may also be provided as part of an adhesive-backed tape or membrane, which is then brought into contact with the opposing surface. In yet another approach, the sealable bonding is accomplished using an adhesive gasket layer, which is placed between the two substrate layers. In any of these approaches, bonding may be accomplished by any suitable method, including pressure-sealing, ultrasonic welding, and heat curing, for example.

In various embodiments, the pipette tip of the present teaching can be adapted to allow rapid heating and cooling of the sample chambers to facilitate reaction of the sample with the analyte-detection reagents, including luminescent dyes. In one embodiment, the pipette tip can be heated or cooled using an external temperature-controller. The temperature-controller is adapted to heat/cool one or more surfaces of the pipette tip, or can be adapted to selectively heat the sample chambers themselves. To facilitate heating or cooling with this embodiment, the pipette tip can be formed of a material that has high thermal conductivity, such as copper, aluminum, or silicon. Alternatively, base can be formed from a material having high thermal conductivity, such that the temperature of the sample chambers can be conveniently controlled by heating or cooling the pipette tip through the base, regardless of the thermal conductivity of the top of the pipette tip. Alternatively, the base can be plastic.

In various embodiments, the sample chambers of the pipette can be pre-loaded with detection reagents that are specific for the selected analytes of interest. The detection reagents can be designed to produce an optically detectable signal via any of the optical methods known in the field of detection. It will be appreciated that although the reagents in each detection chamber can contain substances specific for the analyte(s) to be detected in the particular chamber, other reagents for production of the optical signal for detection can be added to the sample prior to loading, or may be placed at locations elsewhere in the network for mixing with the sample. Whether particular assay components are included in the detection chambers or elsewhere will depend on the nature of the particular assay, and on whether a given component is stable to drying. Pre-loaded reagents added in the detection chambers during manufacture of the substrate can enhance assay uniformity and minimize the assay steps conducted by the end-user. In various embodiments, the pipette tip can be coded with a barcode or electronic labeling device, e.g. RFID, to identify the pre-loaded detection reagents.

In various embodiments, pre-loaded reagents can be separated into a compartment within the sample chamber with a wax layer. After the reagent solutions are dispensed into the sample chambers, wax beads can be added. The sample chambers can be covered during heating to melt the wax. After cooling, the wax forms a tight seal over the reagents. An example of wax that can be used to form the seal is Ampliwax®, Applied Biosystems, Foster City, Calif. The wax provides protection to the reagents during manufacturing completion of the pipette, during shipping, and during processing of the pipette in the instrument.

In various embodiments, the sample can require sample preparation prior to pipetting. A raw biological sample from a syringe can be injected into a fluidic cartridge that provides the sample preparatory reagents and/or separation and then mates directly with the substrate. Such a cartridge integrates the sample preparation and sample introduction into the substrate. The cartridge can also introduce the other reagents for production of the optical signal discussed above.

In various embodiments, the pipette tip can be used to aspirate the sample into each sample chamber by a standard pipettor. The pipette tip can be inserted into the thermal-cycling instrument directly while still connected to the pipettor. The thermal-cycling instrument can be used to seal the input and aspiration channels associated with each sample chamber. The pipette tip can then be disconnected from the pipettor. The thermal-cycling device can include a thermal block with recesses configured to fit the sample chambers and optical sensor that can align with the windows in the top portion of the pipette tip. In various embodiments, the thermal-cycling instrument can be oriented vertically to eliminate the need for a heated cover and permit ergonomic pipette manipulation.

In various embodiments, the analyte to be detected may be any substance whose presence, absence, or amount is desirable to be determined. The detection means can include any reagent or combination of reagents suitable to detect or measure the analyte(s) of interest. It will be appreciated that more than one analyte can be tested for in a single detection chamber, if desired.

In one embodiment, the analytes are selected-sequence polynucleotides, such as DNA or RNA, and the analyte-specific reagents include sequence-selective reagents for detecting the polynucleotides. The sequence-selective reagents include at least one binding polymer that is effective to selectively bind to a target polynucleotide having a defined sequence. The binding polymer can be a conventional polynucleotide, such as DNA or RNA, or any suitable analog thereof, which has the requisite sequence selectivity. Other examples of binding polymers known generally as peptide nucleic acids may also be used. The binding polymers can be designed for sequence specific binding to a single-stranded target molecule through Watson-Crick base pairing, or sequence-specific binding to a double-stranded target polynucleotide through Hoogstein binding sites in the major groove of duplex nucleic acid. A variety of other suitable polynucleotide analogs are also known in the art of nucleic acid amplification. The binding polymers for detecting polynucleotides are typically 10-30 nucleotides in length, with the exact length depending on the requirements of the assay, although longer or shorter lengths are also contemplated.

In one embodiment, the analyte-specific reagents include an oligonucleotide primer pair suitable for amplifying, by polymerase chain reaction, a target polynucleotide region of the selected analyte that is flanked by 3′-sequences complementary to the primer pair. In practicing this embodiment, the primer pair is reacted with the target polynucleotide under hybridization conditions which favor annealing of the primers to complementary regions of opposite strands in the target. The reaction mixture is then thermal cycled through several, and typically about 20-40, rounds of primer extension, denaturation, and primer/target sequence annealing, according to well-known polymerase chain reaction (PCR) methods. Typically, both primers for each primer pair are pre-loaded in each of the respective sample chambers, along with the standard nucleotide triphosphates, or analogs thereof, for primer extension (e.g., ATP, CTP, GTP, and TTP), and any other appropriate reagents, such as MgCI2 or MnCI2. A thermally stable DNA polymerase, such as Taq, Vent, or the like, may also be pre-loaded in the chambers, or may be mixed with the sample prior to sample loading. Other reagents may be included in the detection chambers or elsewhere as appropriate. Alternatively, the detection chambers may be loaded with one primer from each primer pair, and the other primer (e.g., a primer common to all of sample chambers) can be provided in the sample or elsewhere. If the target polynucleotides are single-stranded, such as single-stranded DNA or RNA, the sample is preferably pre-treated with a DNA- or RNA-polymerase prior to sample loading, to form double-stranded polynucleotides for subsequent amplification. This pretreatment can be provided in the cartridge.

In various embodiments, the presence and/or amount of target polynucleotide in a sample chamber, as indicated by successful amplification, is detected by any suitable means. For example, amplified sequences can be detected in double-stranded form by including an intercalating or crosslinking dye, such as ethidium bromide, acridine orange, or an oxazole derivative, for example, which exhibits a fluorescence increase or decrease upon binding to double-stranded nucleic acids. The level of amplification can also be measured by fluorescence detection using a fluorescently labeled oligonucleotide. In this embodiment, the detection reagents include a sequence-selective primer pair as in the more general PCR method above, and in addition, a sequence-selective oligonucleotide (FQ-oligo) containing a fluorescer-quencher pair. The primers in the primer pair are complementary to 3′ regions in opposing strands of the target analyte segment which flank the region which is to be amplified. The FQ-oligo is selected to be capable of hybridizing selectively to the analyte segment in a region downstream of one of the primers and is located within the region to be amplified. The fluorescer-quencher pair can include a fluorescer dye and a quencher dye which are spaced from each other on the oligonucleotide so that the quencher dye is able to significantly quench light emitted by the fluorescer S at a selected wavelength, while the quencher and fluorescer are both bound to the oligonucleotide. The FQ-oligo preferably includes a 3′-phosphate or other blocking group to prevent terminal extension of the 3′ end of the oligo. The fluorescer and quencher dyes may be selected from any dye combination having the proper overlap of emission (for the fluorescer) and absorptive (for the quencher) wavelengths while also permitting enzymatic cleavage of the FQ-oligo by the polymerase when the oligo is hybridized to the target. Suitable dyes, such as rhodamine and fluorscein derivatives, and methods of attaching them, are well known in the art of nucleic acid amplification.

In another embodiment, the detection reagents include first and second oligonucleotides effective to bind selectively to adjacent, contiguous regions of a target sequence in the selected analyte, and which can be ligated covalently by a ligase enzyme or by chemical means as known in the art of oligonucleotide ligation assay, (OLA). In this approach, the two oligonucleotides (oligos) can be reacted with the target polynucleotide under conditions effective to ensure specific hybridization of the oligonucleotides to their target sequences. When the oligonucleotides have base-paired with their target sequences, such that confronting end subunits in the oligos are base-paired with immediately contiguous bases in the target, the two oligos can be joined by ligation, e.g., by treatment with ligase. After the ligation step, the detection wells are heated to dissociate unligated probes, and the presence of ligated, target-bound probe is detected by reaction with an intercalating dye or by other means. The oligos for OLA may also be designed so as to bring together a fluorescer-quencher pair, as discussed above, leading to a decrease in a fluorescence signal when the analyte sequence is present. In the above OLA ligation method, the concentration of a target region from an analyte polynucleotide can be increased, if necessary, by amplification with repeated hybridization and ligation steps. Simple additive amplification can be achieved using the analyte polynucleotide as a target and repeating denaturation, annealing, and ligation steps until a desired concentration of the ligated product is achieved.

In another embodiment, the ligated product formed by hybridization and ligation can be amplified by ligase chain reaction (LCR). In this approach, two sets of sequence-specific oligos are employed for each target region of a double-stranded nucleic acid. One probe set includes first and second oligonucleotides designed for sequence-specific binding to adjacent, contiguous regions of a target sequence in a first strand in the target. The second pair of oligonucleotides is effective to bind (hybridize) to adjacent, contiguous regions of the target sequence on the opposite strand in the target. With continued cycles of denaturation, reannealing and ligation in the presence of the two complementary oligo sets, the target sequence is amplified exponentially, allowing small amounts of target to be detected and/or amplified.

In various embodiments, it will be appreciated that since the selected analytes in the sample can be tested for under substantially uniform temperature and pressure conditions within the substrate, the detection reagents in the various sample chambers should have substantially the same reaction kinetics. This can be accomplished using oligonucleotides and primers having similar or identical melting curves, which can be determined by empirical or experimental methods as are known in the art. In another embodiment, the analyte is an antigen, and the analyte-specific reagents in each detection chamber include an antibody specific for a selected analyte-antigen. Detection may be by fluorescence detection, agglutination, or other homogeneous assay format. As used herein, “antibody” is intended to refer to a monoclonal or polyclonal antibody, an Fc portion of an antibody, or any other kind of binding partner having an equivalent function. For fluorescence detection, the antibody may be labeled with a fluorescer compound such that specific binding of the antibody to the analyte is effective to produce a detectable increase or decrease in the compound's fluorescence, to produce a detectable signal (non-competitive format). In an alternative embodiment (competitive format), the detection means includes (i) an unlabeled, analyte-specific antibody, and (ii) a fluorescer-labeled ligand which is effective to compete with the analyte for specifically binding to the antibody. Binding of the ligand to the antibody is effective to increase or decrease the fluorescence signal of the attached fluorescer. Accordingly, the measured signal can depend on the amount of ligand that is displaced by analyte from the sample In a related embodiment, when the analyte is an antibody, the analyte-specific detection reagents include an antigen for reacting with a selected analyte antibody which may be present in the sample. The reagents can be adapted for a competitive or non-competitive type format, analogous to the formats discussed above. Alternatively, the analyte-specific reagents can include a mono- or polyvalent antigen having one or more copies of an epitope which is specifically bound by the antibody-analyte, to promote an agglutination reaction which provides the detection signal.

In various embodiments, the selected analytes can be enzymes, and the detection reagents include enzyme substrate molecules which are designed to react with specific analyte enzymes in the sample, based on the substrate specificities of the enzymes. Accordingly, detection chambers in the device each contain a different substrate or substrate combination, for which the analyte enzyme(s) may be specific. This embodiment is useful for detecting or measuring one or more enzymes which may be present in the sample, or for probing the substrate specificity of a selected enzyme. Examples of detection reagents include chromogenic substrates such as NAD/NADH, FAD/FADH, and various other reducing dyes, for example, useful for assaying hydrogenases, oxidases, and enzymes that generate products which can be assayed by hydrogenases and oxidases. For esterase or hydrolase (e.g., glycosidase) detection, chromogenic moieties such as nitrophenol may be used, for example.

In various embodiments, the analytes are drug candidates, and the detection reagents include a suitable drug target or an equivalent thereof, to test for binding of the drug candidate to the target. It will be appreciated that this concept can be generalized to encompass screening for substances that interact with or bind to one or more selected target substances. For example, the assay device can be used to test for agonists or antagonists of a selected receptor protein, such as the acetylcholine receptor. In a further embodiment, the assay device can be used to screen for substrates, activators, or inhibitors of one or more selected enzymes. The assay may also be adapted to measure dose-response curves for analytes binding to selected targets.

Reference will now be made to various exemplary embodiments, examples of which are illustrated in the accompanying drawings. Wherever possible, the same reference numbers are used in the drawings and the description to refer to the same or like parts.

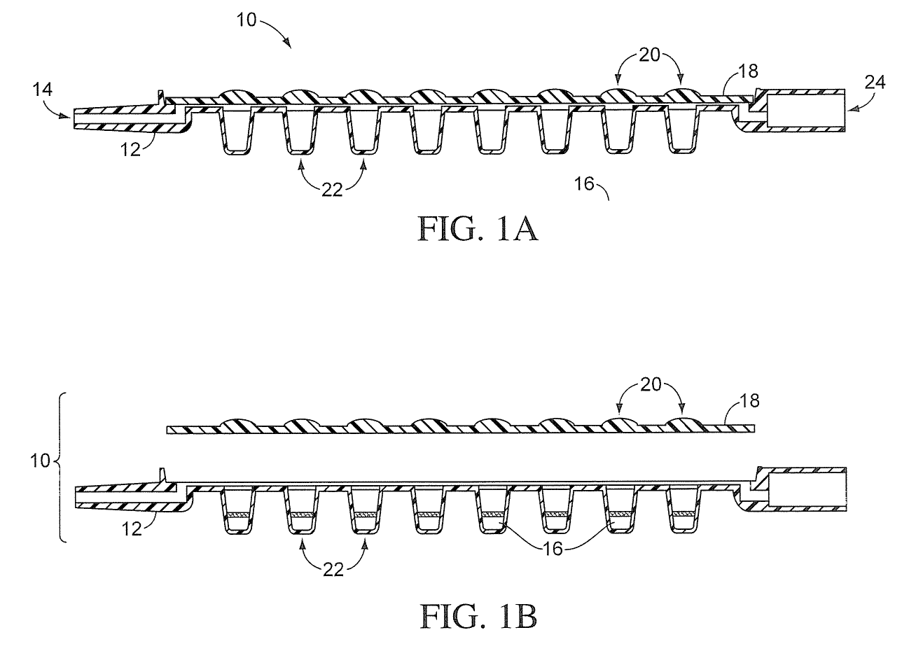

In various embodiments, as illustrated in FIGS. 1A and 1B, the pipette tip 10 has several layers. FIG. 1A illustrates the assembled pipette tip 10 while FIG. 1B illustrates an exploded view of the pipette tip layers. The pipette tip 10 can include sample entry port 14 and a pipettor interface 24. The sample entry port contacts the sample and aspirates the sample into the pipettor tip. The pipettor interface connects to the pipettor to provide aspiration. The pipettor can be a manual pipettor or an automated mechanical pipettor. The pipette tip 10 can include more than one layer. The base 12 can forms the bottom portion of the entry port 14 and pipettor interface 24. The base 12 can form the sample chambers 22 which can fit into the recesses of a block in the thermal-cycling device. The optical layer 18 can provide windows 20 to permit optical access to the sample chambers 22 through the wall of the pipette tip 10. The entire optical layer 18 can provide desirable optical properties or simply the windows 20 provide those properties. The windows can be designed to provide optical power as lenses to focus light into the sample chambers 22 and/or collect luminescent light emitted from the sample chambers 22. The top portion 16 of the pipette tip can form the top portion of the entry port 14 and pipettor interface 24. The top portion 16 can couple the optical layer 18. The base 12 and top portion 16 can be unitary or cast out of one piece.

In various embodiments, the pipette tip 10 as illustrated in FIG. 1 B shows a sample distribution network where each sample chamber is connected in series from the inlet port 14 to the pipettor interface 24. Such as configuration can fill the sample chambers 22 with sample in succession from the one proximate to the inlet port 14 to the one proximate to the pipettor interface 24. The reagents can be kept from mixing with the sample by a wax layer compartment 16. The reagents can be preloaded into each sample chamber 22 and sealed with wax as described above. The wax layer can keep the sample being loaded into each sample chamber 22 from mixing with the reagents. The wax layer compartment 16 also occupies a volume of the sample chamber 22. The volume of the compartment can be designed to occupy enough volume of the sample chamber 22 such that the remainder provides sufficient sample to the sample chamber 22 prior to sample filling the next sample chamber 22. After the sample chamber is sealed, the wax can be melted so that the sample and reagents can mix together. The wax does not interfere with the thermal cycling of the sample and reagents or their reactions.

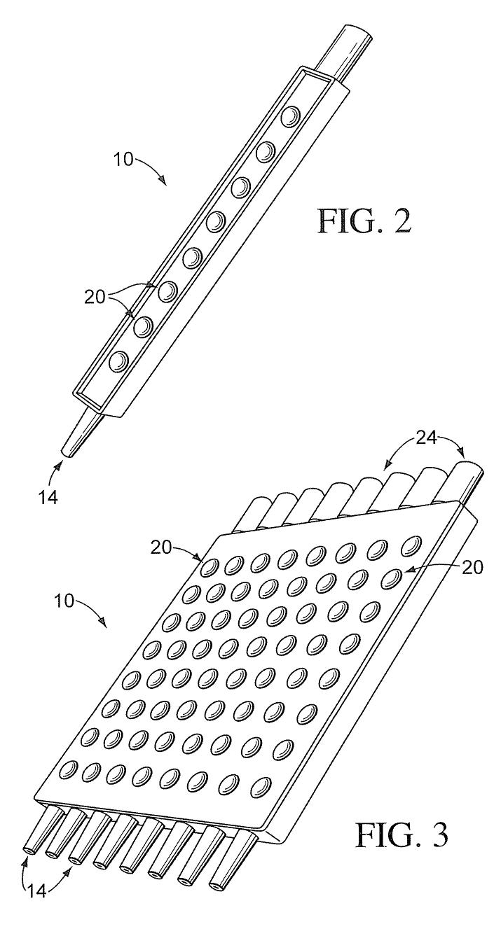

In various embodiments, the pipette tip 10 can include a single row of sample chambers with one inlet port 14 and pipettor interface 24, as illustrated in FIG. 2. Alternatively, the pipette tip 10 can include multiple rows of sample chambers with multiple inlet ports 14 and multiple pipettor interfaces 24, as illustrated in FIG. 3.

In various embodiments, the pipette tip can include a sample distribution network with check valves to prevent the flow of the sample in the reverse direction when aspiration from the pipettor is removed. In such a configuration, the pipette tip can be removed from the pipettor prior to sealing of the sample chambers because the check valves prevent the sample that has been aspirated into the sample chambers from flowing out.

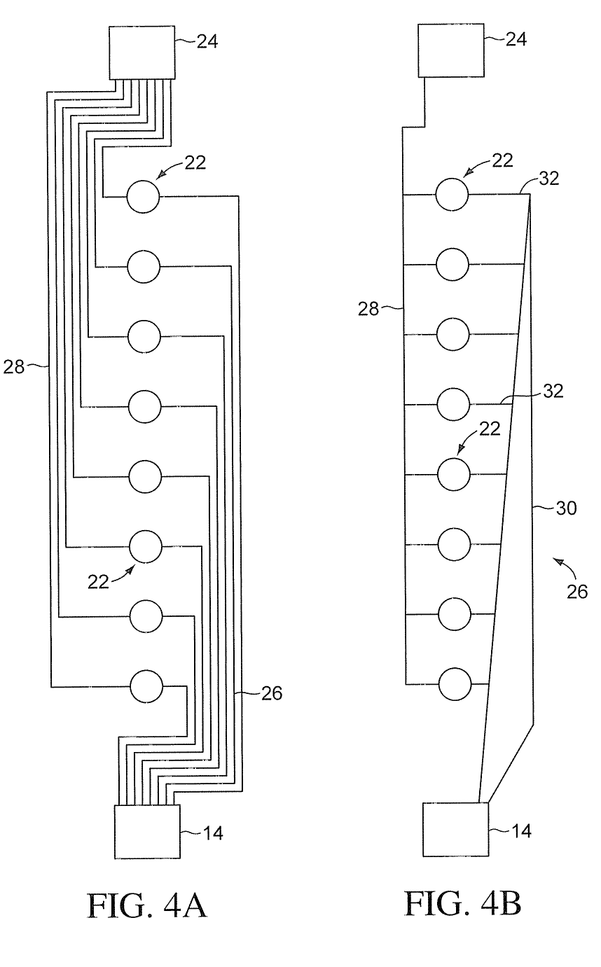

In various embodiments, the pipette tip 10 can be designed to provide a sample-distribution network for sample loading similar amounts of sample into each sample chamber. The sample-distribution network can be parallel branched channels as illustrated in FIG. 4A. Such a network can dedicate one input channel 26 for each sample chamber 22 and one aspiration channel 28 for each sample chamber 22 so that each chamber 22 is filled in parallel at the same time. The lengths of the channels 26, 28 can be designed to provide the same aspiration force to each sample chamber 22. Another example of a sample-distribution network can be serially branched channels as illustrated in FIG. 4B. Such a network can design the branching input channels 32 to be proportionally narrower than the main channel 30 to permit most of the sample to pass to the main channel 30. The main channel 30 can be gradually narrowed after successive branching input channels 32 such that sample chambers 22 are filled in series.

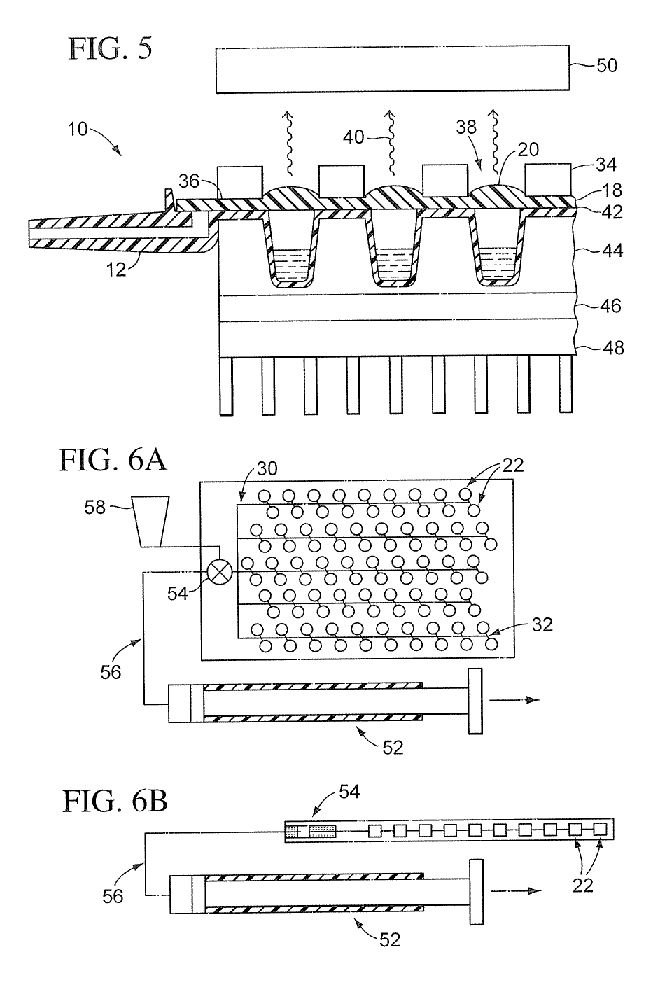

In various embodiments, as illustrate in FIG. 5, the system for thermal cycling a biological sample can include pipette tip 10 with base 12 including the sample chambers 22 and top layer 16 including windows 20 that are constructed of detection-compatible material that can permit emission light 40 to reach detector 50. The system for thermal cycling also can include a lid 34 with sealing contacts 36 and optical openings 38. The sealing contacts 36 align with the inlet channels and aspiration channels (not shown) and optical openings 38 align with the windows 20 and sample chambers 22. The sealing contacts 36 can provide pressure and/or heat to the top layer to form seals 42 around each sample chamber 22. The system for thermal cycling also can include a thermal block 44 with recesses to fit the sample chambers 22, a heater/cooler 46 that can include a resistive heater and/or Peltier cooler, and a heat sink 48 that can radiate heat and/or provide cooling. Several configurations for heating and cooling thermal cycling instruments are known in the art of nucleic acid amplification. The lid 34 can be heated during thermal cycling to reduce condensation of the biological sample.

In various embodiments, the pipettor can be a syringe that removes at least a portion of the air in the sample chambers. As illustrated in FIGS. 6A and 6B, syringe 52 can pull the air out of the sample chambers 22 through sample-distribution network of main channels 30 and branching channels 32 through valve 54 and tubing 56. The sample can then be loaded through inlet port 58. The volume differential according to Boyle's law (P1V1=P2V2) can provide 14.55 pounds per square inch of atmospheric pressure when the syringe displaces 1.00 mL and the sample chambers contain a volume of 10 microliters. For example, a 3.0 mL syringe with an exterior diameter of 1.0 cm exterior diameter can displace 1.00 mL of air with about 1.8 cm linear motion. Examples of valves can be a double-septum valve or rotary valves. The syringe can be manually activated or a spring-like mechanism so that the activity can be driven by stored energy. The pipette tip can include a vent to the environment. The valve position and syringe can be coupled together for coordinated simultaneous movement of the valve body. In various embodiments, the method for loading the pipette tip can include positioning the pipette tip in the thermal cycler, aspirating at least a portion of the air out of the sample chambers, loading the sample chambers through the inlet port, closing the valve to seal the sample chambers, and thermally cycling the samples.

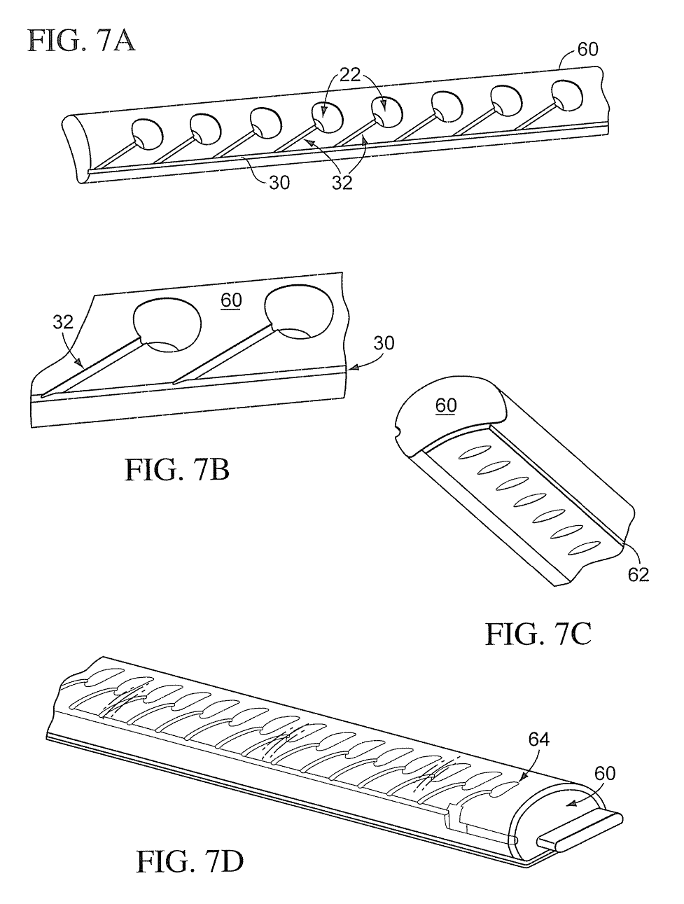

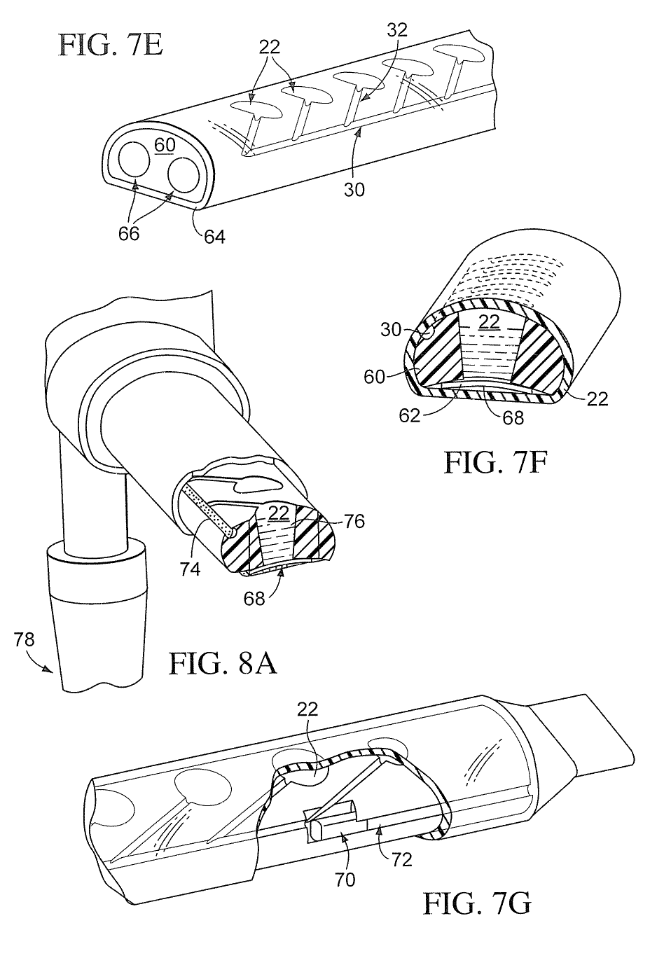

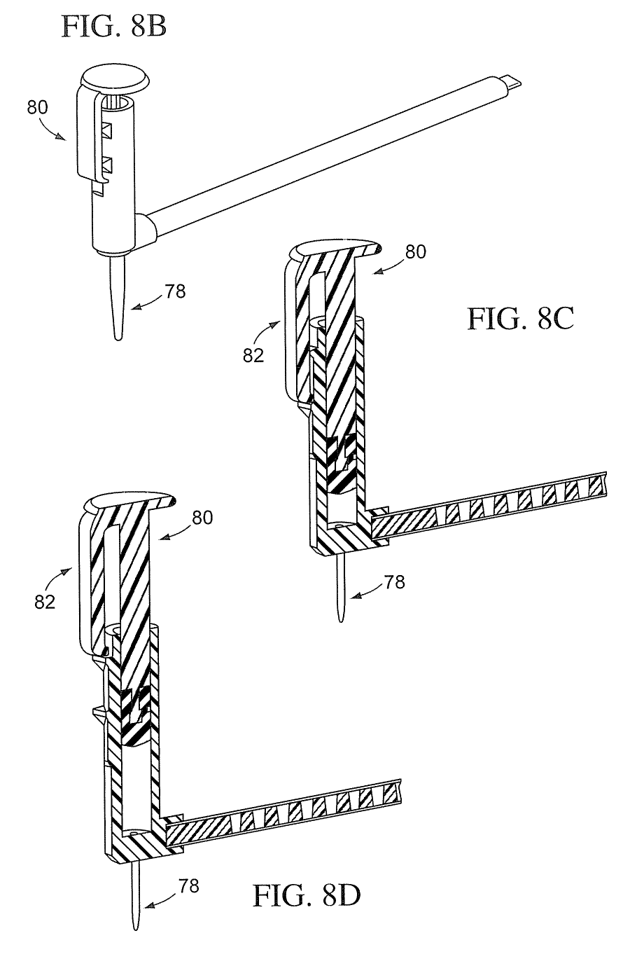

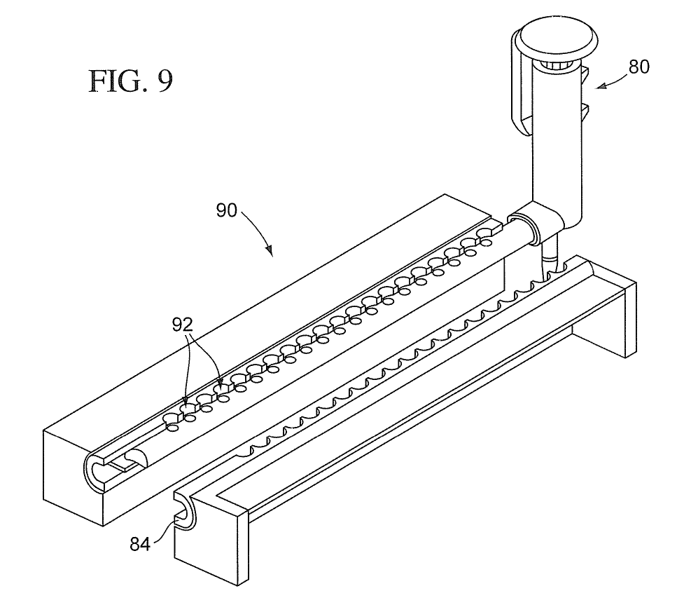

In various embodiments, the pipettor can be positioned on one end of the sample-distribution network. As illustrated in FIGS. 7A-7G, the sample distribution network can be formed into a core 60 with main channel 30, branch channels 32, and sample chambers 22. The core can be constructed of plastic that is injection molded or extruded into a narrow rod and then formed and punched. The core can be formed as continuous reel stock and then optimized into the desired number of sample chambers. The core 60 can be laminated with a membrane 62, for example, a strip of porous, hydrophobic film on the concave side of the core 60 as illustrated in FIG. 7C. The membrane can be welded directly with heat or sonic energy or rolled with a hot melt adhesive to the profile and then pressed in place. Then the reagents can be spotted and dried down into the open side of the chambers on the opposite, convex side. Then the core 60 can be jacketed with an external sleeve 64 that can be unitary or segmented shrink tubing as illustrated in FIG. 7D. End ports 66 can be molded in, formed in place or welded on. FIG. 7E illustrate a cross-sectional view showing the features described above with the addition of an oil channel 68 between the sleeve 64 and membrane 62. FIG. 7F illustrates an example of a venting system with an exit valve 70, for example a polyethylene glycol plug positioned past the last sample chamber 22 which can dissolve after the last well has been filled to open the path for the excess sample liquid to pass and to permit the oil 74 or other isolating immiscible fluid to flow around both sides of the wells to seal and isolate the sample chambers 22 that have been filled with sample 76. Both the sample 76 and oil 74 introduced through inlet port 78 as illustrated in FIG. 8A. In various embodiments, the sample 76 can be introduced through inlet port 78 by pipettor 80 as illustrated in FIGS. 8B. The sample 76 can flow down main channel 30, branching channels 32, and sample chambers 22. The excess air can escape through the membrane and exit through the vent channel 68 formed on the concave side of the core 60. Oil or some other immiscible fluid can be flowed through vent channel 68 to seal off the wells. Oil or some other immiscible fluid can be flowed through the main channel 30 as well displacing the excess sample to completely isolate the sample chambers. In various embodiments, the finished core can be straight or curved in an arc. The core can be several rigid, straight sections with flexible section in between. The core can then be bent back to form a series of rows of sample chambers as in a convention microcard. In various embodiments, the core can be interrogated with optical access via a scanning head that can travel along the length of the core. The core can have low thermal mass and can be completely surrounded by a thermal cycler for rapid thermal cycling by heating on multiple sides, as illustrated in FIG. 9. The sleeve 64 can be a continuous tube with no welded joints except for the ends. The vent channel 68 can be filled with oil 74 or some other immiscible fluid to transmit uniform force to all the sample chambers 22 with substantial pressure without using an airlock. For example, such pressure can be used to force gas bubbles back into solution so that all the sample remain substantially bubble free and condensation does not form during thermal cycling. In various embodiments, the pipettor 80 can be pulled out until the ratchet 82 catches on the first stop, as illustrated in FIG. 8C. This first stop can provide aspiration to pull the sample into the sample chambers until they are filled and/or the valve permits overflow, for example, the polyethylene glycol valve dissolves, and the sample flows into the end distal to the pipettor. In various embodiments, the inlet port can be placed in oil or some other immiscible fluid to aspirate when the pipettor 80 can be pulled out until the ratchet 82 catches on the second stop, as illustrated in FIG. 8D. The oil can then fill the main channel and the vent/oil channel around the membrane. In various embodiments, the core can be clamped between two halves of a heater block of a thermal cycler, as illustrated in FIG. 9. The thermal cycler 90 can include block 84. The thermal block can include any of the following: thin film heater, thermoelectric cooler, air cooling, liquid cooling, and other heating and cooling means known in the art of thermal cycling. In various embodiments, the pipettor can be used to seal the sample distribution network that has been filled with oil or immiscible liquid, as illustrated in FIG. 9. Alternatively, the pipettor can be removed and the core can be sealed with a cap. Alternatively, the pipettor can pressurize the oil gradually during thermal cycling such as to avoid displacement of the sample from the sample chambers and avoid bubble formation. In various embodiments, the upper portion of the core and sleeve permit optical interrogation of the sample chambers for real-time detection during thermal cycling through orifices 92 in thermal cycler 90.

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges subsumed therein. For example, a range of “less than 10” includes any and all subranges between (and including) the minimum value of zero and the maximum value of 10, that is, any and all subranges having a minimum value of equal to or greater than zero and a maximum value of equal to or less than 10, e.g., 1 to 5.

It is noted that, as used in this specification and the appended claims, the singular forms “a,” “an,” and “the” include plural referents unless expressly and unequivocally limited to one referent. Thus, for example, reference to “a layer” includes two or more different layers. As used herein, the term “include” and its grammatical variants are intended to be non-limiting, such that recitation of items in a list is not to the exclusion of other like items that can be substituted or added to the listed items.

Various embodiments of the teachings are described herein. The teachings are not limited to the specific embodiments described, but encompass equivalent features and methods as known to one of ordinary skill in the art. Other embodiments will be apparent to those skilled in the art from consideration of the present specification and practice of the teachings disclosed herein. It is intended that the present specification and examples be considered as exemplary only.

What is claimed is:

1. A pipette tip for aspiration and thermal-cycling of a biological sample, the pipette tip comprising:
a sample inlet port;
a pipettor interface;
multiple sample chambers, wherein the sample chambers are configured to fit into recesses of a thermal cycling block; and
a sample distribution network, wherein the sample distribution network connects the sample inlet port to the pipettor interface.

2. The pipette tip of claim 1, wherein the sample distribution network connects the sample inlet port to each sample chamber via an inlet channel.

3. The pipette tip of claim 2, wherein the inlet channel is of uniform size.

4. The pipette tip of claim 2, wherein the inlet channel is of variable size.

5. The pipette tip of claim 4, wherein the inlet channel comprises a main channel and a branching channel.

6. The pipette tip of claim 5, wherein the main channel decreases in size.

7. The pipette tip of claim 2, wherein the sample distribution network connects the pipettor interface with each sample chamber via an aspiration channel.

8. The pipette tip of claim 7, wherein each aspiration channel comprising at least one of a direct connection and a branched connection.

9. The pipette tip of claim 1, wherein the sample chambers comprise a wax layer compartment.

10. The pipette tip of claim 1, further comprising multiple sample ports, multiple pipettor interfaces and an array of sample chambers.

11. The pipette tip of claim 1, further comprising an optical layer comprising of detection-compatible material, wherein the detection-compatible material aligns with the multiple sample chambers.

12. A system for thermal cycling of a biological sample, the system comprising:
a pipette tip, the pipette tip comprising:
a sample inlet port;
a pipettor interface;
an optical surface, the optical surface comprising of detection-compatible material;
multiple sample chambers; and
a sample distribution network,
wherein the sample distribution network connects the sample inlet port to the pipettor interface, and
wherein the detection-compatible material aligns with the multiple sample chambers; and
a thermal-cycling instrument, the instrument comprising:
a thermal-cycling block, the block comprising multiple recesses configured to fit the sample chambers;
a lid, wherein the lid comprises sealing contacts configured to align with the sample distribution network and optical openings configured to align with the sample chambers; and
an optical detector configured to align with the optical openings, the detection-compatible material, and the sample chambers.

13. The system of claim 12, wherein the sample distribution network comprises an inlet channel and an aspiration channel for each sample chamber.

14. The system of claim 13, wherein the lid provides pressure to form a seal in the inlet channel and the aspiration channel.

15. The system of claim 13, wherein the lid provides heat to form a seal in the inlet channel and the aspiration channel.

16. The system of claim 14, wherein the lid provides heat during the thermal cycling of the biological sample.

17. The system of claim 12, wherein the optical surface further comprises multiple lenses aligned to the sample chambers.

18. The system of claim 12, wherein the instrument further comprises a pipettor configured to connect to the pipettor interface.

19. The system of claim 18, wherein the pipette tip further comprises multiple sample ports, multiple pipettor interfaces, and an array of sample chambers.

20. The system of claim 12, wherein the sample chambers further comprise a wax layer compartment.

21. A system for thermal cycling of a biological sample, the system comprising:
means for storing reagents in a plurality of sample chambers;
means for distributing the sample to the plurality of sample chambers;
means for sealing each of the sample chambers;
means for thermally cycling the biological sample; and
means for detecting the biological sample.
